(19) United States
(12) Patent Application Publication
(10) Pub. No.: US 2011/0105125 A1
(43) Pub. Date: May 5, 2011

(54) METHOD FOR CLEARING INVALID USER EQUIPMENT INFORMATION IN HOME NODE B-GATEWAY

(76) Inventors: Yi Zhao, Beijing (CN); Dajiang Han, Beijing (CN)

(21) Appl. No.: 12/997,464

(22) PCT Filed: Jun. 9, 2009
(86) PCT No.: PCT/KR2009/003084

§ 371 Date: Dec. 10, 2010

(30) Foreign Application Priority Data
Jun. 12, 2008 (CN) 200810109485.2

(51) Int. Cl. H04W 64/00; H04W 36/00; H04W 88/16

(52) U.S. Cl. 455/436; 455/456.5

(57) ABSTRACT

The present invention provides a method for clearing information in a HNB-GW, with a UE being located in a cell under the control of the home Node B, the method comprises steps of: monitoring by the home Node B whether the UE has moved away from the home Node B, the UE being in an idle state, CELL_DCH state, URA_PCH state, CELL_FACH state or CELL_PCH state; sending by the home Node B a message to the HNB-GW, if the UE has moved away; and clearing by the HNB-GW information on the UE in the HNB-GW. With the present invention, the HNB-GW can keep track of the resident state of UE and thus update UE information in real time.

### TECHNICAL FIELD

The present invention relates to communication, and in particular to a method for clearing invalid user equipment information in a home Node B-Gateway (HNB-GW).

### BACKGROUND ART

Home Node B is a technique to utilize an indoor small-sized base station to improve indoor 3G signals. A system structure of a home Node B is illustrated in FIG. 1. The network elements related to the present invention are described as follows.

User equipment 101 is a terminal to receive data.

In additional to support the functions of 3G Node B and radio network controller (RNC), home Node B 102 needs to support new functions required for deploying a home Node B in a radio access network, such as home Node B authentication, home Node B registration and so on.

Home Node B-Gateway (HNB-GW) 103 is a gateway between the home Node B and a core network. A plurality of home Node Bs can be connected under a single HNB-GW. The core network regards the HNB-GW as a virtual radio network controller. The connection between a HNB-GW and a core network is the same as that between a radio network controller and a core network. Mobile Switching Center 104 manages the circuit-domain services in a core network. General packet radio service supporting node 105 manages the packet-domain services in a core network.

A home Node B connects to a HNB-GW through an interface Iu-h, which supports, in addition to conventional Iu processing functions, new functions like authentication, registration, etc. The HNB-GW connects to the Mobile Switching Center through an interface Iu-cs. The HNB-GW connects to the general packet radio service supporting nodes through an interface Iu-ps.

Since a plurality of home Node Bs can be connected under a single HNB-GW, in order to reduce paging load, it is necessary for a home Node B to initiate a User Equipment (UE) registration process to inform the HNB-GW of resident UE information. In this way, the HNB-GW can page a specific UE within the coverage of a single home Node B. FIG. 2 show a conventional UE registration flow in the interface Iu -h.

In FIG. 2, the home Node B initiates a registration request message 201 to the HNB-GW, the message indicating that specified UE information is to be registered in the HNB-GW. The HNB-GW stores the specified UE information and then responds a registration accept message 202 to the home Node B.

In the current state of art, no discussion is made about how to clear the correspondence between a home Node B and UE (which is stored in the HNB-GW) after the UE moves away from the home Node B. If this correspondence is not cleared from the HNB-GW, the HNB-GW may incorrectly implement UE paging within the old home Node B, since the UE can not receive the paging within the old home Node B any more. Meanwhile, if such invalid UE information is not cleared, memory capacity of the HNB-GW will be soon used up. So, it is desirable to propose a method for clearing invalid UE information in the HNB-GW.

### DISCLOSURE OF INVENTION

### Technical Solution

An object of the present invention is to provide a method for monitoring a resident state of a UE in a home Node B and clearing invalid UE information from the home Node B gateway.

According to one aspect of the present invention, a method for clearing information in a home Node B gateway (HNB-GW), with a Use Equipment (UE) being located in a cell under the control of the home Node B, the method comprises steps of:

a) monitoring by the home Node B whether the UE has moved away from the home Node B, the UE being in an idle state, CELL_DCH state, URA_PCH state, CELL-FACH state or CELL-PCH stat;

b) sending by the home Node B a message to the HNB-GW, if the UE has moved away; and

c) clearing by the HNB-GW the information about the UE in the HNB-GW.

According to another aspect of the present invention, a method for clearing information in a home Node B gateway (HNB-GW), with a User Equipment (UE) being located in a cell under the control of the home Node B, the method comprises steps of:

a) finding by a core network node that the UE has moved away from the home Node B;

b) sending by the core network node a message to the HNB-GW of the home Node B;

c) clearing by the HNB-GW the information about the UE in the HNB-GW.

With the present invention, the HNB-GW can keep track of a resident state of the UE and thus update UE information in real time.

### BRIEF DESCRIPTION OF DRAWINGS

FIG. 1 shows the system structure of a home Node B;

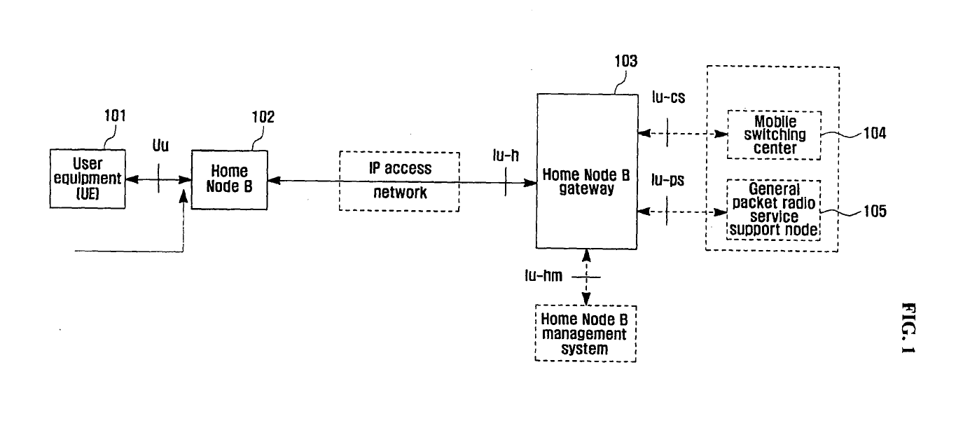

FIG. 2 shows a flowchart of a UE registration process;

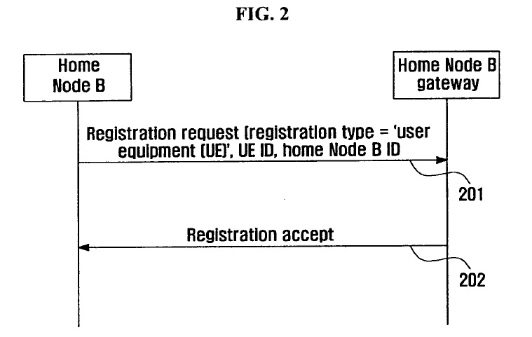

FIG. 3 shows a process that the home Node B triggers the HNB-GW to clear invalid UE information;

FIG. 4 shows a process that an old mobile switching center triggers the HNB-GW to clear invalid UE information;

FIG. 5 shows a process that an old general packet radio service supporting node triggers the HNB-GW to clear invalid UE information;

FIG. 6 shows a process that a mobile switching center triggers the HNB-GW to clear invalid UE information;

FIG. 7 shows a process that a general packet radio service supporting node triggers the HNB-GW to clear invalid UE information.

### MODE FOR THE INVENTION

The present invention provides two solutions for clearing invalid UE information in a HNB-GW. In the first solution, a home Node B monitors the resident state of a UE. When the UE moves away from the home Node B, the old home Node B notifies the HNB-GW to clear invalid UE information, through a novel deregistration process in an interface Iu-h. In the second solution, when the location of a UE changes, the HNB-GW is informed by a mobile switching center/visit location register or a general packet radio service supporting node to clear invalid UE information, through a novel location canceling process via an interface Iu.

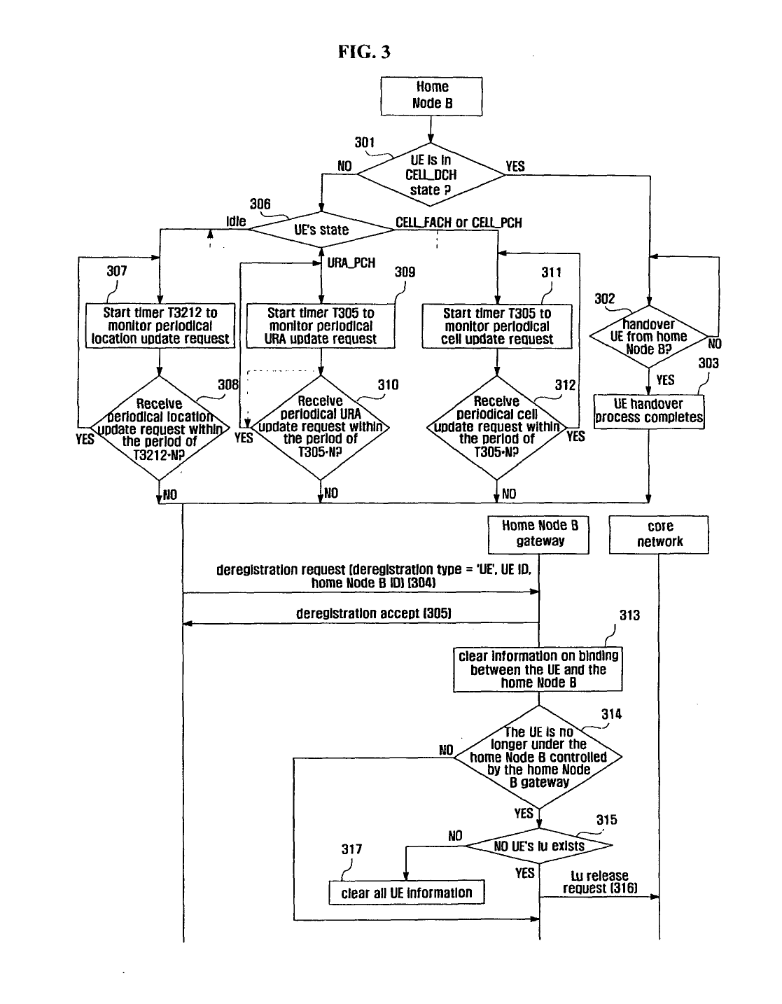

FIG. 3 shows a preferred embodiment of the first solution. In this figure, the home Node B monitors the state of the UE and carries out steps 301 and 306. The home Node B adopts different monitoring approaches depending on different states of the UE. When a UE in a CELL_DCH state is handed-over from the home Node B (Step 302 and Step 303), the home Node B sends a de-registration request message to the HNB-GW (304), the message including deregistration type, UE ID and home Node B ID. After receiving this message, the HNB-GW sends a the HNB-GW accept message as response to the home Node B (306), and clearing the binding information between the UE and the home Node B (Step 313). For a UE in an idle state, the home Node B starts (in Step 307) a timer T3212 to monitor a periodical location update request from the UE. If the home Node B receives no periodical location update request from the UE for a time period of N*T3212 (Step 308), the home Node B initiates (304) a deregistration process to instruct the HNB-GW to clear invalid UE information. For a UE in a URA_PCH state, the home Node B starts (in Step 309) a timer T305 to monitor the periodical URA update request from UE. If the home Node B receives no periodical URA update request from the UE for a time period of N*T305 (Step 310), the home Node B initiates (304) a deregistration process to instruct the HNB-GW to clear invalid UE information.

For a UE in a CELL_FACH or a CELL_PCH state, the home Node B starts (in Step 311) the timer T305 to monitor the periodical cell update request for UE. If the home Node B receives no periodical cell update request (Step 312) from the UE for the time period of N*T305, the home Node B initiates (304) a deregistration process to instruct the HNB-GW to clear invalid UE information. After the HNB-GW clears the binding information of the UE and the home Node B, and if the UE is already not in the home Node B under control of the HNB-GW (Step 314), the HNB-GW determines whether the Iu connection of UE still exists. If yes (Step 315), the HNB-GW sends (316) a Iu connection release request to the core network to require releasing of the Iu connection for UE. Otherwise, the HNB-GW clears all information about the UE (Step 317).

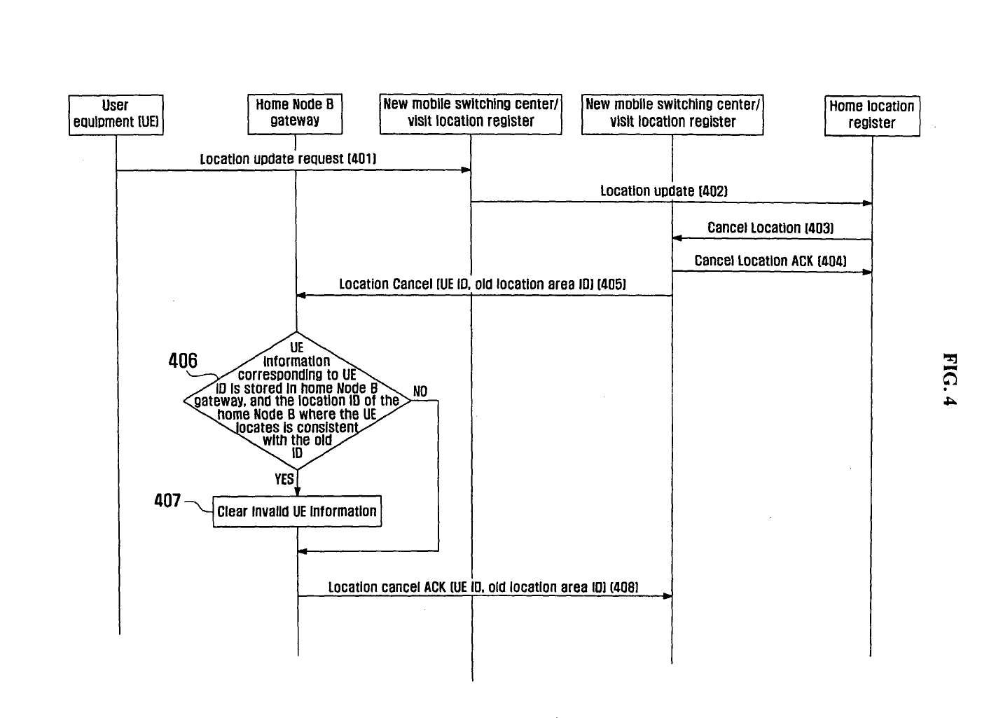

FIGS. 4 through 7 show preferred embodiments of the second solution.

FIG. 4 shows a scenario where the UE changes its location, and the mobile switching center/visit location register also changes. In this figure, the UE initiates (401) a location update request to a new mobile switching center/visit location register. The new mobile switching center/visit location register instructs the home location register to update the location information for UE (402). The home location register sends a “cancel Location” to the old mobile switching center/visit location register (403). After the home location register receives an acknowledgement message (404), the old mobile switching center/visit location register sends (405) a “location cancel” to the home Node B, including the UE ID and the old location cell ID. After receiving this message, the HNB-GW checks whether the UE information corresponding to the UE ID has been stored locally, according to the UE ID included in the message and whether the location area ID of the home Node B in the UE information corresponding to the UE is consistent with the old location area ID in the message 405 (Step 406). If there is any UE information satisfying the above requirements, the HNB-GW will delete the location correspondence between the UE and the home Node B (Step 407). At this time, if there is no Iu connection between the UE and the core network, the HNB-GW will clear every elements of the UE information. Then, the HNB-GW sends (408) a location cancel ACK message to the old mobile switching center as a response. On the other hand, if there is no UE information satisfying the requirements as mentioned at Step (406), the HNB-GW does not have to carry out any deletion operation, but to directly send (408) the location canceling ACK message to the old mobile service switching center as a response.

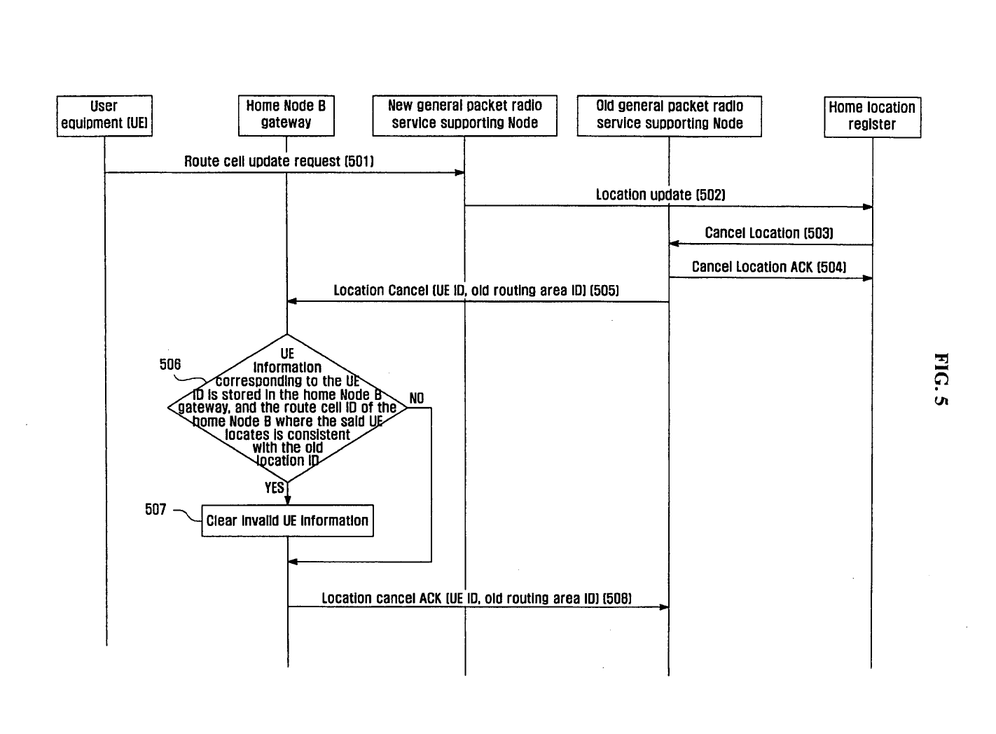

FIG. 5 shows an example that can be applied to a scenario where UE changes its location, while the general packet radio service supporting node is changed. In this figure, the UE initiates (501) a route area update request to a new general packet radio service supporting node. The new general packet radio service supporting node instructs (502) the home location register to update the location information for UE. The home location register sends (503) a Cancel Location message to the old general packet radio service supporting node. After the home location register receives the corresponding ACK message (504), the old general packet radio service supporting node sends (505) a location cancel message to the HNB-GW, the message including the UE ID and the old route area ID. After receiving this message, the HNB-GW checks whether the UE information corresponding to the UE ID has been stored locally, according to the UE ID included in the message. And in the UE information, the route area ID of the home Node B corresponding to the UE is consistent with the old routing area ID in the message (Step 506). If there is any UE information satisfying the above requirements, the HNB-GW will delete the location correspondence between the UE and the home Node B (Step 507).

At this time, if no Iu connection exists between the UE and the core network, the HNB-GW will clear every elements of the UE information, and send (508) a Cancel Location message to the old general packet radio service supporting node as a response. If there is no UE information satisfying the requirements at Step 506, the HNB-GW does not have to carry out any deletion operation, but to directly send (508) a location canceling ACK message to the old general packet radio service supporting node as a response.

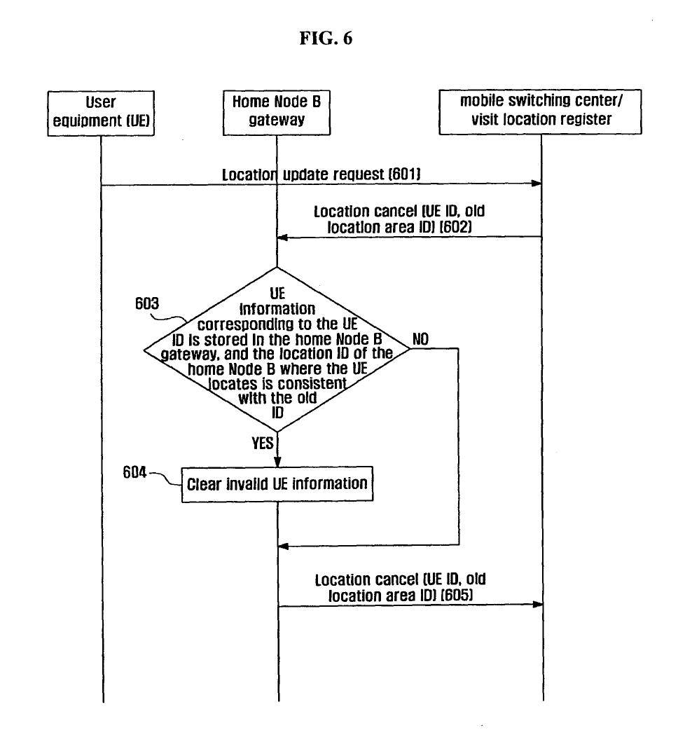

FIG. 6 shows an example that can be applied to a scenario that UE changes its location, while the mobile switching center/visit location register is not changed. In this figure, the UE initiates (601) a location update request to the mobile switching center/visit location register. Once the mobile switching center/visit location register detects that the UEs location area ID has changed, it sends (602) a location cancel message to the HNB-GW, the message including the UE ID and the old location area ID. After receiving this message, the HNB-GW checks whether the UE information corresponding to the UE ID has been stored locally, according to the UE ID included in the message and and in the UE information, the location cell ID of the home Node B corresponding to the UE is consistent with the old location area ID in the message (Step 603). If there is any UE information satisfying the above requirements, the HNB-GW will delete the location correspondence between the UE and the home Node B (Step 604). At this time, if no Iu connection exists between the UE and the core network, the HNB-GW will clearing every elements of the UE information , and send (605) a Cancel Location ACK message to the old mobile switching center as a response. On the other hand, if there is no UE information satisfying the requirements at Step 603, the HNB-GW does not have to delete any information, but to directly send (605) the Cancel Location ACK message to the old mobile switching center as a response.

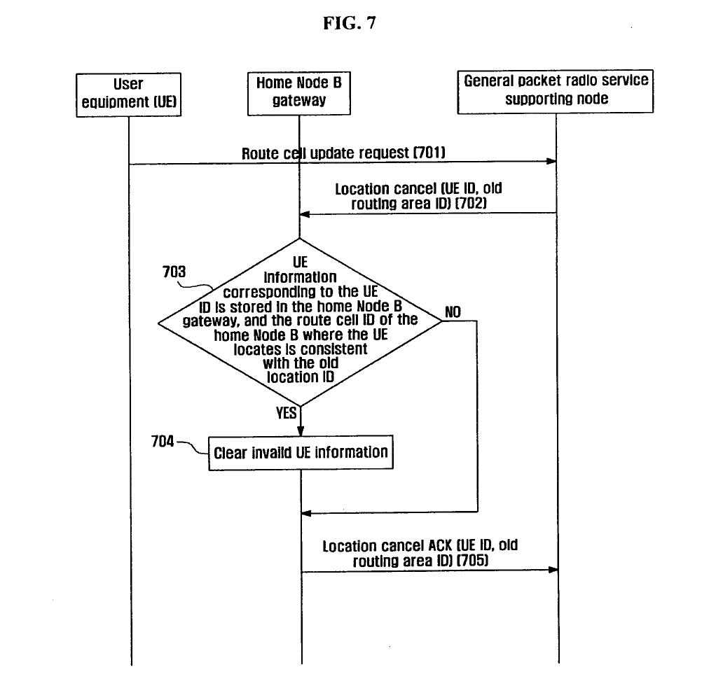

FIG. 7 shows an example that can be applied to a scenario where UE changes its location, while the general packet radio service supporting node is not changed. In this figure, the UE initiates (701) a route area update request to the general packet radio service supporting node. Once the general packet radio service supporting node detects that the UE's routing area ID has changed, it sends (702) a location canceling message to the HNB-GW, the message including the UE ID and the old route area ID. After receiving this message, the HNB-GW checks whether the UE information corresponding to the UE ID has been stored locally, according to the UE ID included in the message and whether in the UE information, the route area ID of the home Node B corresponding to the UE is consistent with the old location cell ID in the message (Step 703). If there is any UE information satisfying the above requirements, the HNB-GW will delete the location correspondence between the UE and the home Node B (Step 704). At this time, if no Iu connection exists between the UE and the core network, the HNB-GW will clearing every elements of the UE information and send (705) a Cancel Location ACK message to the general packet radio service supporting node as a response. On the other hand, if there is no UE information satisfying the requirements at Step 703, the HNB-GW does not have to delete any information, but to directly send (705) the Cancel Location ACK message to the old general packet radio service supporting node as a response.

The above so-called invalid UE information can be information on binding between UE and a specified home Node B, or any other information not necessary to be saved in the gateway when the UE has moved away from the home Node B.

In the present invention, the home Node B can be, but not limited to, a home Node B in UMTS, LTE or any other communication system.

1. A method for clearing information in a home Node B gateway (HNB-GW), the method comprising:
monitoring by the home Node B whether the UE has moved away from the home Node B, the UE being in an idle state, CELL_DCH state or URA_PCH state, CELL-FACH state or CELL PCH state;
sending by the home Node B a message to the HNB-GW; and
clearing by the HNB-GW the information about the UE in the HNB-GW.

2. The method of claim 1, wherein the information is information on binding between the UE and the home Node B.

3. The method of claim 1, wherein the UE is handed-over from the home Node B, when the UE is in CELL_DCH state.

4. The method of claim 1, wherein when the UE is in an idle state, the home Node B starts a timer to monitor any periodical location update request from the UE; the home Node B receives no periodical location update request from the UE within a predetermined time period.

5. The method of claim 1, wherein when the UE is in URA_PCH state, the home Node B starts a timer to monitor any periodical URA update request from the UE; the home Node B receives no periodical URA update request from the UE for a predetermined time period.

6. The method of claim 1, wherein when the UE is in CELL_FACH or CELL-PCH state, the home Node B starts a timer to monitor any periodical cell update request from the UE; the home Node B receives no periodical cell update request from the UE for a predetermined time period.

7. A method for clearing information in a home Node B gateway (HNB-GW), with a User Equipment (UE) being located in a cell under control of a home Node B, the method comprising:
finding by a core network node that the UE has moved away from the home Node B;
sending by the core network node a message to the HNB-GW of the home Node B;
clearing by the HNB-GW information on the UE in the HNB-GW.

8. The method of claim 7, wherein the information is information on binding between the UE and the home Node B.

9. The method of claim 7, further comprising receiving by the core network node a message from the UE, and finding that new location information for the UE is not consistent with old location information for the UE.

10. The method of claim 7, further comprising receiving by the core network node a location canceling message from the UE.
